(19) United States
(12) Patent Application Publication
(10) Pub. No.: US 2012/0173091 A1
(43) Pub. Date: Jul. 5, 2012

(54) MONITORING SYSTEM FOR A MOBILE MACHINE

(75) Inventor: Ramadev Burigsay Hukkeri, Pittsburgh, PA (US)

(73) Assignee: Caterpillar Inc.

(21) Appl. No.: 12/980,963

(22) Filed: Dec. 29, 2010

(51) Int. Cl. G06F 19/00

(52) U.S. Cl. 701/50

(57) ABSTRACT

A mobile machine includes a chassis operably connected to a wheel to support the chassis from an underlying surface. The mobile machine may also include a camera mounted to the mobile machine in a position to capture an image of at least a portion of the wheel during travel of the mobile machine. The mobile machine may also include a controller operable to receive a signal from the camera and to produce an output related to a state of traction of the wheel relative to the surface based at least in part on the signal from the camera.

### TECHNICAL FIELD

The present disclosure relates to mobile machines and, more particularly, systems for monitoring one or more operating parameters and conditions of a wheel of mobile machine.

### BACKGROUND

Many mobile machines rely on wheels to propel, support, and direct them as they travel across an underlying terrain surface. Such wheels may include, for example, a rim with a hub connected to an axle of the mobile machine and an elastomer tire mounted on the rim. The dynamics of a mobile machine supported on an underlying terrain surface by wheels may be related to the interaction of the wheels with the terrain surface. For example, a mobile machine may exhibit undesirable dynamics if one or more of its wheels slip excessively with respect to an underlying terrain surface.

Published U.S. Patent Application No. 2010/0174454 A1 to Saito (“the '454 application”) discusses a system and method purported to detect and address wheel slip of a vehicle. The '454 application discloses that its system may evaluate whether wheel slip is occurring based at least in part on the speeds of different wheels of the vehicle. When the system of the '454 patent deems that wheel slip is occurring, it reduces power transmitted to the wheels.

Although the '454 patent discloses a system and method purported to detect and address wheel slip of a vehicle, the disclosure of the '454 patent may have certain shortcomings. For example, the '454 patent provides no explanation of how to accurately detect wheel speeds and/or any other parameters for use in evaluating whether wheel slip is occurring. It merely states that the tire slip detection means of the controller detects the occurrence of tire slip based on signals measured by sensors in various parts of the vehicle.

The monitoring system of the present disclosure solves one or more of the problems set forth above.

### SUMMARY

One disclosed embodiment relates to a mobile machine having a chassis operably connected to a wheel to support the chassis from an underlying surface. The mobile machine may also include a camera mounted to the mobile machine in a position to capture an image of at least a portion of the wheel during travel of the mobile machine. The mobile machine may also include a controller operable to receive a signal from the camera and to produce an output related to a state of traction of the wheel relative to the surface based at least in part on the signal from the camera.

Another embodiment relates to a method of operating a mobile machine. The method may include supporting a chassis of the mobile machine from an underlying surface at least partially with a wheel resting on the surface. The method may also include, while the wheel is moving across the surface, sensing a value of at least one parameter indicative of a rolling radius of the wheel. The method may also include generating information related to a state of traction of the wheel relative to the surface based at least in part on the sensed value.

A further disclosed embodiment relates to a mobile machine having a chassis operably connected to a wheel to support the chassis from an underlying surface. The mobile machine may include at least one sensor mounted to the mobile machine and operable to generate a signal indicative of a sensed value of at least one parameter indicative of a rolling radius of the wheel while the wheel moves across the surface. The mobile machine may also include a controller operable to receive the signal and generate information related to a state of traction of the wheel relative to the surface based at least in part on the signal.

### BRIEF DESCRIPTION OF THE DRAWINGS

FIG. 1 is a schematic illustration in elevation of one embodiment of a mobile machine according to the present disclosure;

FIG. 2 is a schematic illustration in plan of a mobile machine with one embodiment of a monitoring system according to the present disclosure;

FIG. 3 is a schematic illustration in plan of a mobile machine with another embodiment of a monitoring system according to the present disclosure; and

FIG. 4 is a schematic illustration in plan of a mobile machine with another embodiment of a monitoring system according to the present disclosure.

### DETAILED DESCRIPTION

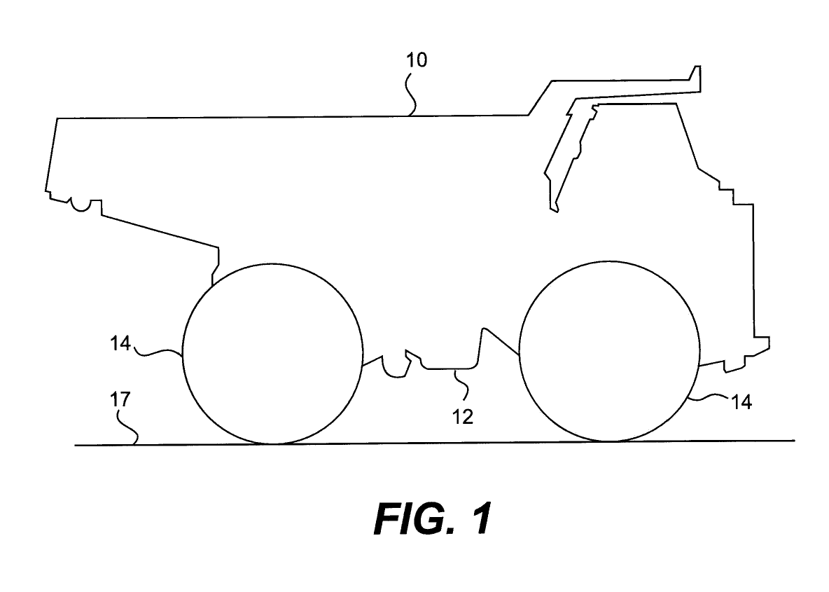

FIG. 1 illustrates in side elevation one embodiment of a mobile machine 10 according to the present disclosure. Mobile machine 10 may include a chassis 12 operably connected to wheels 14 that support mobile machine 10 from an underlying terrain surface 17 (such as the ground or a road). Mobile machine 10 may be configured to perform a variety of tasks. For example, mobile machine 10 may be a mobile machine configured to transport or move people, goods, or other matter or objects. Additionally, or alternatively, mobile machine 10 may be configured to perform a variety of other operations associated with a commercial or industrial pursuit, such as mining, construction, energy exploration and/or generation, manufacturing, transportation, and agriculture. In the example shown in FIG. 1, mobile machine 10 is shown as a hauling machine with a dump body configured to haul bulk material, such as soil. In other embodiments, mobile machine 10 may be an excavator, an earthmoving machine, a compactor, or any other type of machine operable to travel across terrain surface 17.

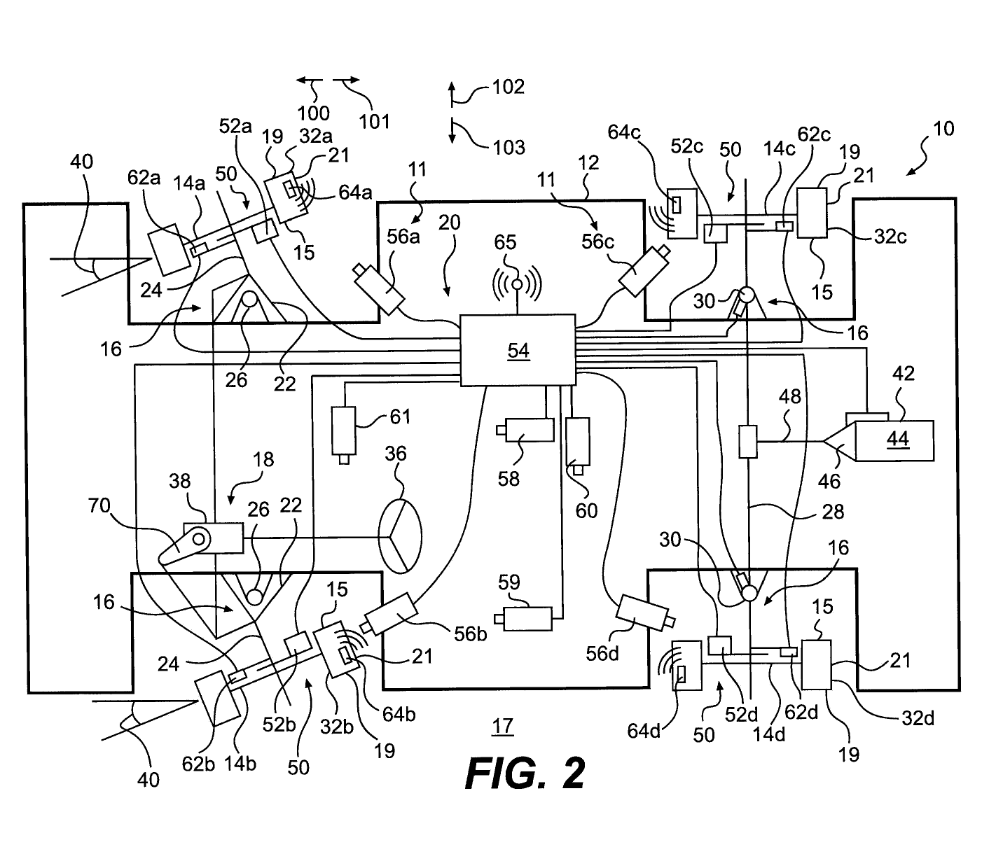

FIG. 2 illustrates in plan view one embodiment of mobile machine 10 having a monitoring system 11 according to the present disclosure. Like the embodiment of mobile machine 10 shown in FIG. 1, the embodiment of mobile machine 10 shown in FIG. 2 may include a chassis 12 operable connected to wheels 14 to support chassis 12 from terrain surface 17. The wheels 14 of mobile machine 10 may include a wheel 14a, a wheel 14b, a wheel 14c, and a wheel 14d. A suspension system 16 may operably connect wheels 14a-14d to chassis 12. Wheels 14a-14d and suspension system 16 may support chassis 12 from the terrain surface 17 underlying wheels 14a-14d. Mobile machine 10 may also include a steering system 18, a propulsion system 42, and a braking system 50. Monitoring system 11 may include various sensors connected to an information system 20 for gathering information related to the operation of mobile machine 10.

Suspension system 16 and wheels 14a-14d may have any configuration suitable for supporting mobile machine 10 from terrain surface 17 as mobile machine 10 travels. In some embodiments, a front portion of suspension system 16 may include control arms 22 connected to chassis 12, stub axles 24 pivotally connected to control arms 22, and struts 26 that control the vertical motion of control arms 22 and stub axles 24 relative to chassis 12. A rear portion of suspension system 16 may include, for example, an axle 28 and struts 30 that connect axle 28 to chassis 12 and control vertical motion between chassis 12 and axle 28. In some embodiments, wheels 14a-14d may include tires 32a, 32b, 32c, 32d mounted on rims. Tires 32a-32d may be pneumatic or non-pneumatic tires. Each wheel 14a-14d may include an inside axial face 15, an outside axial face 19, and a radial perimeter 21. The front portion of suspension system 16 and wheels 14a, 14b may be spaced from the rear portion of suspension system 16 and wheels 14c, 14d in longitudinal directions 100, 101 of mobile machine 10. Wheels 14a, 14c may be spaced from wheels 14b, 14d in lateral directions 102, 103 of mobile machine 10. Lateral directions 102, 103 may be transverse to longitudinal directions 100, 101.

Steering system 18 may have any configuration suitable for controlling the heading of mobile machine 10 as it travels across terrain surface 17. In some embodiments, steering system 18 may be an Ackerman-type steering system. As FIG. 2 shows, steering system 18 may include one or more steering input devices 36, such as a steering wheel, for controlling one or more steering actuators 38, such as a steering box, to control a steering angle 40 of wheels 14a and 14b. Alternatively, steering system 18 may include various other types of actuators for controlling steering angle 40. For example, steering system 18 may include one or more hydraulic cylinders for controlling steering angle 40. Additionally, steering system 18 may steer mobile machine 10 in other ways besides moving wheels 14a, 14b relative to chassis 12. For example, steering system 18 may additionally or alternatively move wheels 14c, 14d relative to chassis 12. In some embodiments, steering system 18 may additionally or alternatively articulate portions of chassis 12 relative to one another to steer mobile machine 10. Steering system 18 may be configured to allow manual control of the direction of travel by an operator on mobile machine 10, remote control of the direction of travel by an operator located off of mobile machine 10, and/or partially or fully automatic control of the direction of travel of mobile machine 10.

Propulsion system 42 may have any configuration capable of propelling mobile machine 10 across terrain surface 17. In some embodiments, for example, propulsion system 42 may include an engine 44, a transmission 46, and a driveshaft 48 drivingly connected to wheels 14c and 14d through axle 28. Propulsion system 42 may also include various other components for transmitting power to propel mobile machine 10, including, but not limited to, torque converters, final drives, electric generators, and electric motors.

Braking system 50 may include any component or components operable to controllably resist motion of mobile machine 10 across terrain surface 17. In some embodiments, braking system 50 may include braking units 52a, 52b, 52c, 52d associated with each wheel 14a-14d and configured to selectively and controllably resist rotation of wheels 14a-14d, respectively.

Information system 20 may include various components configured to receive information from the one or more sensors of mobile machine 10 and perform one or more tasks with the received information. For example, information system 20 may include a controller 54 communicatively linked to one or more sensors on mobile machine 10. Controller 54 may include one or more microprocessors and one or more memory devices. Controller 54 may be configured (i.e., programmed) to perform various tasks based on information from sensors on mobile machine 10. In some embodiments, controller 54 may be communicatively linked to and configured (i.e., programmed) to control one or more aspects of the operation of braking system 50, steering system 18, and/or propulsion system 42. Controller 54 may also be configured (i.e., programmed) to provide information to one or more other control components, including other controllers, for purposes such as allowing such other control components to provide effective control of associated systems and components. Additionally, controller 54 may be configured (i.e., programmed) to provide information to various individuals. For example, controller 54 may be configured (i.e., programmed) to provide information to an operator of mobile machine 10 through an operator interface (not shown) and/or to provide information to service personnel through a service interface (not shown).

Monitoring system 11 may include various sensors communicatively linked to information system 20. In some embodiments, mobile machine 10 may include cameras 56a, 56b, 56c, 56d for capturing images of wheels 14a, 14b, 14c, 14d, respectively. Each camera 56a-56d may be any type of camera suitable for capturing an image in a sufficiently clear manner to allow identification of certain portions of the associated wheel 14a, 14b, 14c, 14d.

Each camera 56a-56d may be mounted to mobile machine 10 in any position where the camera 56a-56d can monitor at least a portion of the associated wheel 14a-14d. In some embodiments, one or more of cameras 56a-56d may be mounted in such a position that the images they capture include at least a portion of the radial perimeter 21 of the associated wheel 14a-14d, as well as at least a portion of either the inside axial face 15 or outside axial face 19 of the wheel 14a-14d. For example, as FIG. 2 shows, camera 56a may be mounted to mobile machine 10 behind and laterally inward of wheel 14a, and pointed at an outward angle such that camera 56a may capture an image of at least a portion of the inside axial face 15 and at least a portion of the radial perimeter 21 of wheel 14a. Camera 56b may be similarly situated relative to wheel 14b. Additionally, cameras 56c and 56d may be mounted forward of wheels 14c, 14d but otherwise positioned generally the same with respect to wheels 14c and 14d as cameras 56a and 56b are positioned with respect to wheels 14a and 14b. Cameras 56a-56d may also be oriented such that the images they capture also include at least a portion of the terrain surface 17, which may be useful for various purposes like measuring a speed of mobile machine 10 relative to terrain surface 17 in one or more directions. In some embodiments, mobile machine 10 may have provisions for illuminating objects in the viewing areas of cameras 56a-56d at night. For example, mobile machine 10 may include one or more lights pointed at the portions of wheels 14a-14d and terrain surface 17 that are within the viewing areas of cameras 56a-56d.

In some embodiments, mobile machine 10 may also have provisions for keeping the lenses of cameras 56a-56d clean. For example, mobile machine 10 may include one or more shields (not shown) for keeping dirt and/or debris off of cameras 56a-56d. Similarly, mobile machine 10 may have provisions for cleaning the lenses of cameras 56a-56d, such as a system (not shown) for automatically spraying cleaning fluid on the camera lenses.

In addition to cameras 56a-56d, monitoring system 11 may include other provisions capable of sensing the speed of mobile machine 10 relative to terrain surface 17 in one or more directions. For example, monitoring system 11 may include a ground speed sensor 58 and a ground speed sensor 60. Ground speed sensor 58 may be configured and positioned to sense a longitudinal speed of mobile machine 10 relative to terrain surface 17. Ground speed sensor 60 may be configured and positioned to sense a lateral speed of mobile machine 10 relative to terrain surface 17. Each ground speed sensor 58, 60 may include any components operable to sense a speed of mobile machine 10 relative to terrain surface 17, including, but not limited to, radar and/or an optical camera paired with a laser range finder.

In some embodiments, monitoring system 11 may be configured in a manner to determine a yaw rate of mobile machine 10. This may include a single component or sensor by itself, or it may include multiple components or sensors. Where, for example, one or both of ground speed sensors 58, 60 include an optical camera paired with a laser range finder, controller 54 may be configured (i.e., programmed) to use the signal from the optical camera and the associated laser range finder of one of ground speed sensors 58, 60 to determine a yaw rate of mobile machine 10. This may involve the controller 54 using consecutive images from the camera and the information from the laser range finder to determine the yaw rate.

In addition to, or instead of information from an optical camera and a laser range finder, monitoring system 11 may have various other ways to determine the yaw rate of mobile machine 10. For example, in some embodiments, mobile machine 10 may have additional ground speed sensors, such as a ground speed sensor 59 and a ground speed sensor 61. Ground speed sensor 59 may be configured and positioned to sense a longitudinal velocity of mobile machine 10. Ground speed sensor 59 may be spaced laterally from ground speed sensor 58. Using information from ground speed sensors 58, 59 about the longitudinal velocity of mobile machine 10 at different lateral positions, controller 54 may determine the yaw rate of mobile machine 10. This may involve, for example, calculating the yaw rate of mobile machine based at least in part on a known lateral distance between ground speed sensors 58, 59 and a difference between the ground speeds measured by ground speed sensors 58, 59. Monitoring system 11 may similarly have an additional ground speed sensor 61 configured and positioned to determine a lateral velocity of mobile machine 10 at a position longitudinally spaced from ground speed sensor 60 on mobile machine 10. Controller 54 may also use the information about the lateral velocity of mobile machine 10 at different longitudinal positions on mobile machine 10 to determine a yaw rate of mobile machine 10. This may involve, for example, using information about a known longitudinal distance between ground speed sensors 60, 61 and a difference between the ground speeds sensed by these sensors. In determining the yaw rate of mobile machine 10, controller 54 may use the information about the lateral velocity of mobile machine 10 at different longitudinal positions by itself or in combination with information about the longitudinal velocity of mobile machine 10 at different lateral positions.

Monitoring system 11 may implement provisions other than those discussed above for determining a yaw rate of mobile machine 10. For example, monitoring system 11 may use global positioning system (GPS) devices located on different parts of mobile machine 10 to determine yaw rate. Alternatively, monitoring system 11 may use one or more inertial measurement units, such as accelerometers, on mobile machine 10 to determine the yaw rate of mobile machine 10.

In addition to ground speed sensors 58-61, monitoring system 11 may include wheel-speed sensors. For example, mobile machine 10 may include one wheel-speed sensor 62a, 62b, 62c, 62d for sensing the speed of each of wheels 14a, 14b, 14c, 14d, respectively. Each wheel-speed sensor 62a-62d may include any configuration of components operable to determine a rotational or linear speed of the associated wheel 14a-14d. In some embodiments, each wheel-speed sensor 62a-62d may sense the rotational speed of a disc connected to the associated wheel 14a-14d, thereby generating a signal indicative of an angular speed of the associated wheel 14a-14d.

Mobile machine 10 may also include provisions for determining an air pressure within tires 32a-32d. For example, mobile machine 10 may include pressure sensors 64a-64d configured to sense air pressure within tires 32a-32d. Pressure sensors 64a-64d may have any configuration and may be attached to mobile machine 10 in any manner suitable for sensing pressure within tires 32a-32d. For example, as FIG. 2 shows, pressure sensors 64a-64d may be mounted within tires 32a-32d.

Cameras 56a-56d, ground speed sensors 58-61, wheel-speed sensors 62a-62d, and pressure sensors 64a-64d may be communicatively linked to information system 20 in any manner that allows transmission of information gathered by these sensors to information system 20. As FIG. 2 shows, many of these sensors may be communicatively linked to controller 54 by communication cables. Alternatively, one or more of these sensors may be communicatively linked to controller 54 wirelessly. For example, as FIG. 2 shows, pressure sensors 64a-64d may communicate wirelessly with controller 54 via a transceiver 65.

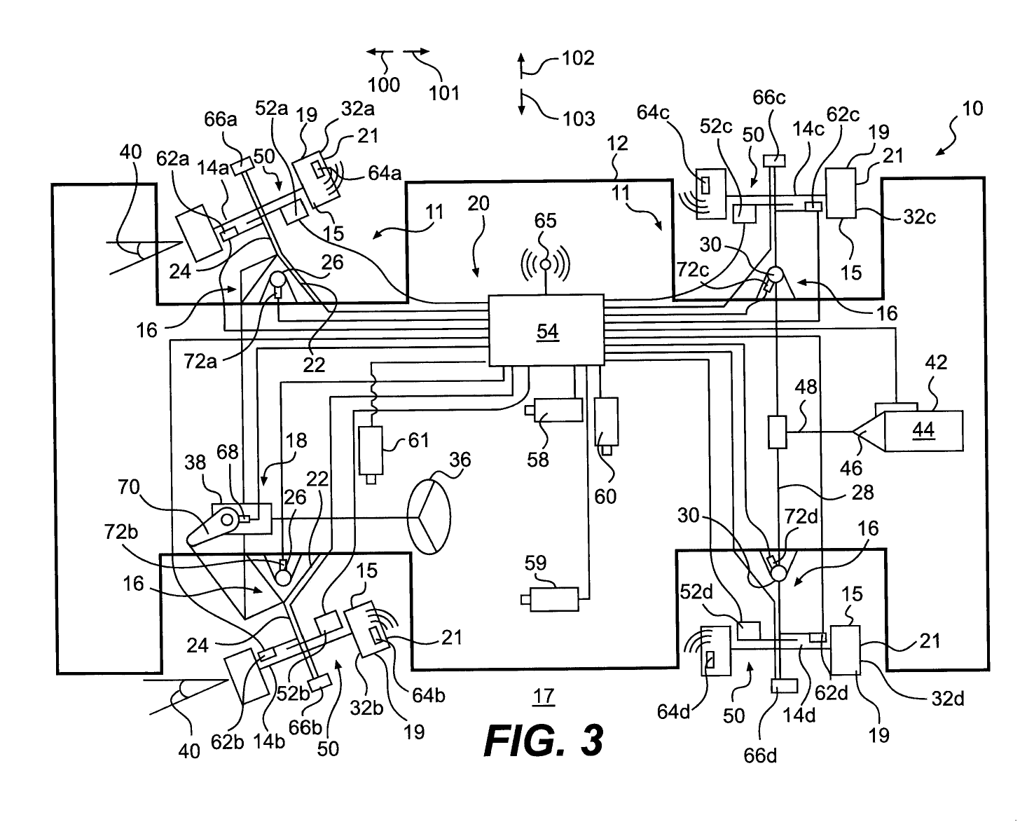

FIG. 3 shows another embodiment of monitoring system 11 according to the present disclosure. The embodiment of monitoring system 11 shown in FIG. 3 may be substantially the same as the embodiment shown in FIG. 2, except for the omission of cameras 56a-56d and the inclusion of a number of other sensors communicatively linked to information system 20. In the embodiment shown in FIG. 3, mobile machine 10 may include a sensor 66a, 66b, 66c, 66d associated with each wheel 14a, 14b, 14c, 14d, respectively, for sensing a parameter indicative of the wheel's rolling radius. The rolling radius of a wheel 14a, 14b, 14c, 14d may be a vertical distance from a central axis of the wheel (e.g. the center of the stub axle 24 or axle 28 to which the wheel is mounted) to the bottom portion of the wheel 14a, 14b, 14c, 14d in contact with the underlying terrain 17. The rolling radius of a wheel 14a, 14b, 14c, 14d may vary during operation of mobile machine 10 because certain parts of the wheel 14a, 14b, 14c, 14d (e.g. the tire 32a, 32b, 32c, 32d) may compress by varying amounts in different situations. Each sensor 66a-66d may be, for example, a sensor mounted adjacent the associated wheel 14a-14d and configured to measure a distance from the sensor down to a portion of terrain surface 17 adjacent the wheel 14a-14d. In such embodiments, each sensor 66a-66d may be any type of component operable to sense a distance to terrain surface 17. In some embodiments, sensors 66a-66d may be laser range finders. Sensors 66a-66d may mount to various components adjacent wheels 14a-14d. In the example shown in FIG. 3, sensors 66a and 66b may each mount to an end portion of one of stub axles 24, and sensors 66c and 66d may each mount to an end portion of axle 28.

In addition to sensors 66a-66d, the embodiment of monitoring system 11 shown in FIG. 3 may include provisions for sensing the position of one or more components of steering system 18. For example, mobile machine 10 may include a steering angle sensor 68. Steering angle sensor 68 may be any component operable to sense the position of one or more components of steering system 18 whose position is related to the steering angle 40 of wheels 14a, 14b. For example, steering angle sensor 68 may be an encoder configured to sense an angular position of an arm 70 of steering actuator 38. Additionally or alternatively, a commanded steering position may be sensed by sensing operator inputs, such as by sensing a position of steering input 36.

To enable information system 20 to account for bump steer in using the information from steering angle sensor 68 to determine steering angle 40, mobile machine 10 may also include provisions for sensing the jounce at each of wheels 14a-14d. For example, mobile machine 10 may include jounce sensors 72a, 72b, 72c, 72d associated with each of wheels 14a, 14b, 14c, 14d, respectively. Each jounce sensor 72a-72d may have any configuration that allows sensing a parameter indicative of vertical movement of suspension system 16 at each wheel 14a-14d. As FIG. 3 shows, each of jounce sensors 72a and 72b may be configured to sense the position and/or vertical movement of one or more components of one of struts 26, and jounce sensors 72c and 72d may be configured to sense the vertical position and/or vertical movement of one or more components of one of struts 28. Thus, jounce sensors 72a, 72b, 72c, 72d may allow monitoring system 11 to determine bump steer and various other parameters. Bump steer may be change in steering angle 40 resulting from movement of suspension system 16 without change in the commanded steering angle.

Rolling-radius sensors 66a-66d, steering angle sensor 68, and jounce sensors 72a-72d may be communicatively linked to information system 20 in any manner that allows communicating the sensed information to information system 20. For example, as shown in FIG. 3, these sensors may be communicatively linked to controller 20 with communication cables.

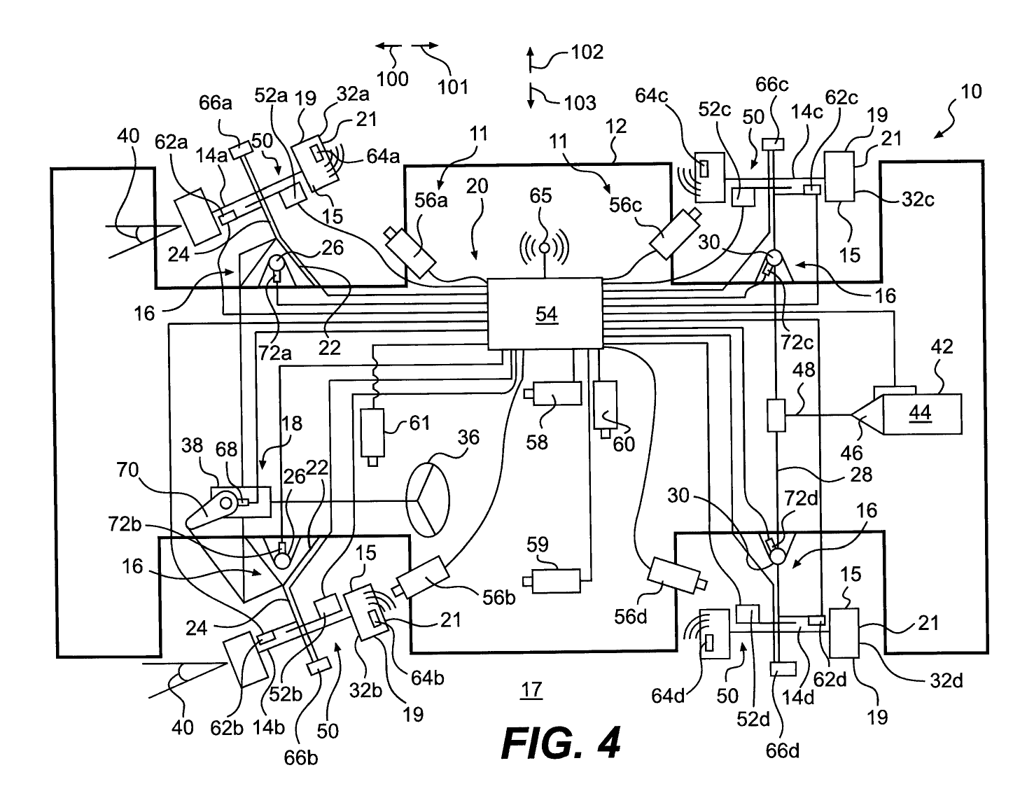

FIG. 4 shows another embodiment of monitoring system 11 according to the present disclosure. The embodiment of monitoring system 11 shown in FIG. 4 may be substantially the same as the embodiment shown in FIG. 3, except that the embodiment of FIG. 4 may include cameras 56a-56d like the embodiment shown in FIG. 2.

Mobile machine 10 and monitoring system 11 are not limited to the configurations shown in FIGS. 1-4 and discussed above. For example, the chassis 12, wheels 14a-14d, suspension system 16, steering system 18, propulsion system 42, and braking system 50 of mobile machine 10 may have different configurations than those discussed and shown. Additionally, monitoring system 11 may include various other sensors communicatively linked to information system 20, and/or mobile machine 10 may omit various of the sensors shown in FIGS. 2-4. Information system 20 may also have a different configuration than shown in FIGS. 2-4. For example, information system 20 may have one or more other controllers, in addition to controller 54. In such embodiments the controllers and sensors of mobile machine 10 may be communicatively linked in various ways. In some embodiments, one or more sensors may be communicatively linked directly to one controller, and that controller may indirectly link those sensors to other controllers. Additionally, or alternatively, one or more of the sensors and/or controllers may be linked to a common communication bus.

### INDUSTRIAL APPLICABILITY

Monitoring system 11 may have use in any application where it may prove helpful to accurately measure one or more parameters and/or conditions related to the operating state of one or more wheels of a mobile machine 10. During operation of mobile machine 10, monitoring system 11 may generate a variety of information helpful for controlling one or more aspects of the operation of mobile machine 10. For example, monitoring system 11 may generate output information related to a state of traction of each of wheels 14a-14d with respect to terrain surface 17. This information may include, but is not limited to, estimates of longitudinal and lateral wheel slip, estimates of body slip angle and wheel slip angle, estimates of an amount of traction available, and predictions of excessive wheel slip. This information may be used by the controls of mobile machine 10, such as controller 54, to control one or more aspects of the operation of mobile machine 10. For example, controller 54 may form part of a dynamic stability control system that uses this information to control one or more aspects of the operation of braking system 50, steering system 18, and propulsion system 42 according to one or more dynamic stability control algorithms. Additionally, monitoring system 11 may use this information and/or other information from cameras 56a-56d and/or ground speed sensors 58-61 to help accurately determine the position of mobile machine 10. This may have use in a variety of applications, including applications where mobile machine 10 may be autonomously controlled.

The information available from the disclosed configurations of monitoring system 11 may provide enhanced accuracy in the estimation of various operating parameters. For example, the disclosed configurations of monitoring system 11 may enable estimating longitudinal wheel slip with a high degree of accuracy. As used herein, longitudinal wheel slip refers to slippage of the radial perimeter 21 of a wheel 14a-14d on terrain surface 17 in the direction it is rolling. In some embodiments, controller 54 may calculate an estimate of a percentage of longitudinal wheel slip at each wheel 14a-14d, which may be determined, for instance, with the following equations:

$$L W V = R W S \times R R$$

$$Slong = 1 - \frac{L W V}{L G S}$$

Where, LWV is the longitudinal velocity of the radial perimeter 21 of a wheel 14a-14d at terrain surface 17, RWS is the rotational speed of the wheel 14a-14d, RR is the rolling radius of the wheel 14a-14d, LGS is the longitudinal ground speed of mobile machine 10, and Slong is the longitudinal wheel slip of the wheel 14a-14d. Monitoring system 11 may determine the rotational speed RWS of each wheel 14a-14d using information from each of wheel-speed sensors 62a-62d. Monitoring system 11 may determine the longitudinal ground speed LGS of mobile machine 10 using information from ground-speed sensor 58.

Monitoring system 11 may also used sensed information to determine the rolling radius RR of each wheel 14a-14d. For example, information system 20 may use information from each of cameras 56a-56d to determine the rolling radius of each of wheels 14a-14d, such as by using image-processing technology to identify a lower portion and a center portion of each wheel 14a-14d and determining a distance between these points. In addition to, or instead of the information from cameras 56a-56d, monitoring system 11 may use the information from sensors 66a-66d to determine the rolling radius RR of each of wheels 14a-14d. In some embodiments, such as the one shown in FIG. 3, monitoring system 11 may use the information from sensors 66a-66d by itself to determine the rolling radius RR of each wheel 14a-14d. In embodiments like the one shown in FIG. 4 that include both sensors 66a-66d and cameras 56a-56d, monitoring system 11 may use information from sensors 66a-66d in combination with information from cameras 56a-56d to determine the rolling radius of each wheel 14a-14d. As mobile machine 10 travels across terrain surface 17, monitoring system 11 may repeatedly redetermine all of these sensed and calculated values.

In addition to longitudinal wheel slip, monitoring system 11 may monitor lateral wheel slip. As used herein, lateral wheel slip refers slippage of the radial perimeter 21 of a wheel 14a-14d on terrain surface 17 in a direction transverse to the direction it is rolling. In some embodiments, controller 54 may calculate an estimate of a percentage of lateral wheel slip at each wheel 14a-14d, which may be determined, for instance, with the following equation:

$$Slat = 1 - \frac{A L V}{T L V}$$

Where ALV is the actual lateral velocity of mobile machine 10, TLV is the theoretical lateral velocity of mobile machine 10, and Slat is the calculated estimate of lateral wheel slip for a given wheel. Monitoring system 11 may determine the actual lateral velocity ALV of mobile machine 10 using information from ground speed sensor 60. The theoretical lateral velocity TLV is the lateral velocity that would occur if none of wheels 14a-14d slips laterally. Monitoring system 11 may determine the theoretical lateral velocity TLV of mobile machine 10 based on the steering angle 40 of wheels 14a and 14b, the measured longitudinal ground speed LGS, and the wheelbase of mobile machine 10.

Monitoring system 11 may use various information to determine the steering angle 40 of wheels 14a and 14b. In some embodiments, monitoring system 11 may determine the steering angle 40 of wheels 14a, 14b based solely on information from cameras 56a, 56b by using image-processing technology to evaluate images of wheels 14a, 14b received from cameras 56a, 56b. In other embodiments, such as embodiments where monitoring system 11 does not include cameras 56a, 56b, monitoring system 11 may use, for example, information from steering angle sensor 68 and jounce sensors 72a-72d to determine the steering angle 40 of wheels 14a, 14b. In embodiments like those shown in FIG. 4 that include cameras 56a, 56b, steering angle sensor 68, and jounce sensors 72a-72d, monitoring system 11 may use information from all of these sources to determine the steering angle 40 of wheels 14a, 14b. Monitoring system 11 may repeatedly or continuously reevaluate all of these sensed and calculated values as mobile machine 10 travels across terrain surface 17.

In addition to longitudinal and lateral wheel slip values, monitoring system 11 may monitor a body slip angle SΘBODY of mobile machine 10. The body slip angle SΘBODY may be an angle between the longitudinal direction 100 of mobile machine 10 and a vector describing the direction mobile machine 10 is moving with respect to terrain surface 17. Monitoring system 11 may determine the vector describing the direction of travel of mobile machine 10 using the information provided by ground speed sensors 58-61. For example, controller 54 may use information from ground speed sensor 58 to determine the speed of mobile machine 10 in longitudinal direction 100 or 101 relative to terrain surface 17, and controller 54 may use the information from ground speed sensor 60 to determine the speed of mobile machine 10 in either lateral 102 or 103 relative to terrain surface 17. Controller 54 may additionally or alternatively use information from one or more of cameras 56a, 56b, 56c, and 56d to determine the longitudinal speed and the lateral speed of mobile machine 10 relative to terrain surface 17. Having determined the lateral and longitudinal speeds of mobile machine 10 relative to terrain surface 17, controller 54 may determine the vector describing the velocity of mobile machine 10 relative to terrain surface 17. Controller 54 may then determine the body slip angle SΘBODY of mobile machine 10 by determining the angle between the longitudinal direction 100 of mobile machine 10 and the vector describing the velocity of mobile machine 10 relative to terrain surface 17.

Having determined the body slip angle SΘBODY of mobile machine 10, controller 54 may also determine a wheel slip angle SΘWa, SΘWb, SΘWc, SΘWd for each of wheels 14a, 14b, 14c, 14d. Controller 54 may do so, for example, with the following equations:

SΘWa=WΘa−SΘBODY

SΘWb=WΘb−SΘBODY

SΘWc=WΘc−SΘBODY

SΘWd=WΘd−SΘBODY

Where SΘBODY is the previously determined body slip angle, WΘa is the angle of wheel 14a relative to longitudinal direction 100 of mobile machine 10, WΘb is the angle of wheel 14b relative to longitudinal direction 100 of mobile machine 10, WΘc is the angle of wheel 14c relative to longitudinal direction 100 of mobile machine 10, and WΘd is the angle of wheel 14d relative to longitudinal direction 100 of mobile machine 10. In the circumstances shown in FIGS. 2-4, WΘa and WΘb may be equal to steering angle 40, and WΘc and WΘd may be equal to zero.

In addition to monitoring the current values of lateral wheel slip, longitudinal wheel slip, body slip angle, and wheel slip angle, monitoring system 11 may predict when a wheel 14a, 14b, 14c, 14d may experience reduced traction or traction loss and excessive wheel slip may occur. Monitoring system 11 may use various sensed and/or calculated values to do so. In some embodiments, monitoring system 11 may estimate an amount of traction available at each of wheels 14a-14d to predict when reduced traction or loss of traction of one or more of wheels 14a-14d becomes imminent. Monitoring system 11 may estimate the amount of traction available at each of wheels 14a-14d based at least in part on an estimated load on each of wheels 14a-14d. To estimate the load on a given wheel 14a-14d, monitoring system 11 may determine the air pressure in the tire 32a-32d of that wheel 14a-14d, as well as the rolling radius of the wheel 14a-14d. With this information, monitoring system 11 may use empirical and/or theoretical information about the relationship between tire pressure, rolling radius, and load to estimate a load on each of wheels 14a-14d. Monitoring system 11 may then use this information in combination with empirical and/or theoretical information about the relationship between the loading of a given wheel 14a-14d and the amount of traction available at the wheel 14a-14d to estimate the amount of traction available at the wheel 14a-14d. Monitoring system 11 may repeatedly or continuously redetermine all of these sensed and calculated values.

It will be appreciated that the above-discussed equations and methods for determining longitudinal wheel slip, lateral wheel slip, body slip angle, and wheel slip angle may assume values of certain variables. For example, the foregoing equations may assume that yaw rate of mobile machine 10 is zero. This approach may provide a suitable estimate of the various parameters discussed above. Additionally, however, it is contemplated that various embodiments of monitoring system 11 may factor in additional variables to determine the parameters discussed above. For example, monitoring system 11 may factor in the yaw rate of mobile machine 10 in determining various of the parameters discussed above. This may be accomplished in any known or suitable manner.

The disclosed configurations may provide a number of advantages related to accurately and effectively determining the values of various parameters related to the dynamic stability of mobile machine 10 as it travels across terrain surface 17. Using cameras 56a-56d to capture images of wheels 14a-14d may help monitoring system 11 efficiently and reliably determine the value of a number of operating parameters of the wheels 14a-14d, including the steering angle 40 and the instantaneous rolling radius, at any given time. Because the information in any given image of a wheel 14a-14d is all captured at the same time, monitoring system 11 can use such an image to determine the value of various different parameters of the wheel 14a-14d with full confidence that those values all occurred at the same time. This may provide significant benefits related to reliability, accuracy, and simplicity of the monitoring and control process.

Additionally, the disclosed approach of repeatedly or continuously sensing the actual rolling radius of each wheel 14a-14d may significantly contribute to the accuracy of various parameters monitored by monitoring system 11. For example, this may contribute significantly to accurate monitoring of longitudinal wheel slip of each of wheels 14a-14d. As discussed above, some embodiments of monitoring system 11 may estimate a percentage of longitudinal wheel slip for a given wheel 14a-14d based at least in part on the rolling radius of the wheel 14a-14d. The rolling radius of a wheel 14a-14d may vary during travel of mobile machine 10 across terrain surface 17 due to various influences, such as undulations in terrain surface 17. By sensing such variations in the rolling radius of each wheel 14a-14d, the disclosed embodiments may help ensure accurate determination of longitudinal wheel slip.

The information gathered by monitoring system 11 may be used in various ways. In some embodiments, the information may be used to perform dynamic stability control and/or traction control. Dynamic stability control may involve controller 54 controlling one or more aspects of the operation of steering system 18, propulsion system 42, and/or braking system 50 to enhance the dynamic stability of mobile machine 10. Traction control may involve, for example, controller 54 using the gathered information to control one or more aspects of propulsion system 42 to maintain traction of those wheels 14a, 14b, 14c, 14d used to drive mobile machine 10. For example, if controller 54 determines that a wheel 14a, 14b, 14c, 14d being used to drive mobile machine 10 is about to slip or is currently slipping, controller 54 may reduce the amount of power transmitted to that wheel 14a, 14b, 14c, 14d. In addition to the foregoing uses, the information gathered by monitoring system 11 may be used for a variety of other purposes. For example, the information from cameras 56a-56d and/or ground speed sensors 58-61 may be used to help track the position of mobile machine 10. This may be useful in a number of applications, including applications where mobile machine 10 may be navigated autonomously. Any combination of one or more of the above-discussed sensed and/or calculated values gathered by monitoring system 11 may be used in any suitable manner for dynamic stability control, traction control, determining the position of mobile machine 10, and/or other uses.

Operation of monitoring system 11 is not limited to the examples discussed above. For instance, monitoring system 11 may forgo determination of one or more of the parameters discussed above, including, but not limited to, longitudinal wheel slip, lateral wheel slip, body slip angle, wheel slip angle, anticipated wheel slip, estimated wheel loading, and/or the rolling radius of each wheel. Additionally, monitoring system 11 may determine the values of various sensed and/or calculated parameters other than those discussed above. Also, in determining the values of the above-discussed and/or other parameters, monitoring system 11 may rely on information from different configurations and combinations of sensors than those discussed above.

It will be apparent to those skilled in the art that various modifications and variations can be made in the disclosed monitoring system without departing from the scope of the disclosure. Other embodiments of the disclosed monitoring system will be apparent to those skilled in the art from consideration of the specification and practice of the monitoring system disclosed herein. It is intended that the specification and examples be considered as exemplary only, with a true scope of the disclosure being indicated by the following claims and their equivalents.

What is claimed is:

1. A mobile machine, comprising:
a chassis operably connected to a wheel to support the chassis from an underlying surface;
a camera mounted to the mobile machine in a position to capture an image of at least a portion of the wheel during travel of the mobile machine across the surface;
a controller operable to receive a signal from the camera and to produce an output related to a state of traction of the wheel relative to the surface based at least in part on the signal from the camera.

2. The mobile machine of claim 1, wherein the controller is configured to determine a wheel slip percentage based on the signal from the camera.

3. The mobile machine of claim 1, wherein:
the mobile machine further includes a ground-speed sensor; and
the controller is configured to determine a wheel-slip percentage based at least in part on the signal from the camera and information from the ground-speed sensor.

4. The mobile machine of claim 1, wherein the controller is configured to determine a steering angle of the wheel based at least in part on the signal from the camera.

5. The mobile machine of claim 4, wherein the controller is configured to determine a lateral slip percentage of the wheel relative to the surface based at least in part on the determined steering angle of the wheel.

6. The mobile machine of claim 1, wherein the controller is configured to determine a rolling radius of the wheel based at least in part on the signal from the camera.

7. The mobile machine of claim 7, wherein the controller is configured to determine a longitudinal slip percentage of the wheel relative to the surface based at least in part on the determined rolling radius of the wheel.

8. The mobile machine of claim 1, wherein the controller is configured to perform dynamic stability control based at least in part on the output related to a state of traction of the wheel relative to the surface.

9. The mobile machine of claim 8, wherein the controller is configured to predict reduced traction of the wheel on the surface based at least in part on the estimated load on the wheel.

10. The mobile machine of claim 1, wherein the controller is configured to determine a body slip angle of the mobile machine and a wheel slip angle of the wheel based at least in part on the signal from the camera.

11. A method of operating a mobile machine, the method comprising:
supporting a chassis of the mobile machine from an underlying surface at least partially with a wheel resting on the surface;
while the wheel is moving across the surface, sensing a value of at least one parameter indicative of a rolling radius of the wheel; and
generating information related to a state of traction of the wheel relative to the surface based at least in part on the sensed value.

12. The method of claim 11, wherein sensing a value of at least one parameter indicative of a rolling radius of the wheel includes monitoring at least one portion of the wheel with a camera.

13. The method of claim 12, further performing traction control based at least in part on the sensed value.

14. The method of claim 12, further including determining a steering angle of the wheel with information from the camera.

15. The method of claim 14, further including determining a lateral slip percentage of the wheel relative to the surface based at least in part on the determined steering angle.

16. The method of claim 12, wherein generating information related to a state of traction of the wheel relative to the underlying surface based at least in part on the sensed value includes generating an estimate of a longitudinal slip percentage of the wheel relative to the surface based at least in part on the value.

17. The method of claim 12, wherein sensing a value of at least one parameter indicative of a rolling radius of the wheel includes sensing a distance to the surface with a sensor mounted on the mobile machine adjacent the wheel.

18. A mobile machine, comprising:
a chassis operably connected to a wheel to support the chassis from an underlying surface;
at least one sensor mounted to the mobile machine and operable to generate a signal indicative of a sensed value of at least one parameter indicative of a rolling radius of the wheel while the wheel moves across the surface; and
a controller operable to receive the signal and generate information related to a state of traction of the wheel relative to the surface based at least in part on the signal.

19. The mobile machine of claim 18, further comprising:
a propulsion system configured to propel the mobile machine across the surface; and
wherein the controller is configured to perform traction-control based at least in part on the signal.

20. The mobile machine of claim 18, wherein the at least one sensor mounted to the mobile machine and operable to generate a signal indicative of sensed value of at least one parameter indicative of a rolling radius of the wheel while the wheel moves across the surface includes a camera mounted to the mobile machine in a position to capture an image of at least a portion of the wheel during travel of the mobile machine.
